(19) United States
(12) Patent Application Publication
(10) Pub. No.: US 2021/0171816 A1
(43) Pub. Date: Jun. 10, 2021

(54) A WORKING FLUID

(71) Applicant: FUTURE ENERGY SOURCE LIMITED, Dorset (GB)

(72) Inventor: Zulfiqar KHAN, Dorset (GB)

(73) Assignee: FUTURE ENERGY SOURCE LIMITED, Dorset (GB)

(21) Appl. No.: 16/768,817

(22) PCT Filed: Nov. 30, 2018
(86) PCT No.: PCT/IB2018/059528

§ 371 Date: Jun. 1, 2020

(30) Foreign Application Priority Data
Nov. 30, 2017 (GB) 1719974.6

(51) Int. Cl. C09K 5/10

(52) U.S. Cl. CPC C09K 5/10; B82Y 30/00

(57) ABSTRACT

A working fluid for use in a heat transfer system, for example of the type used to transfer heat in a heat engine. The working fluid comprises a plurality of nano-particles suspended in a base fluid so as to improve a heat transfer property of the base fluid. Ideally the nano-particles are suspended in the base fluid in a colloidal suspension. A system for manufacturing a nano-fluid is also described. The system includes a plurality of hoppers for containing types of nano-particle and a reservoir that contains a base fluid. A control means controls valves on the hoppers and on the reservoir in order to dispense working fluid and defined amounts of nano-particles into a mixer tank. A mixer mixes the nano-particles with the base fluid to produce a nano-fluid which is in colloidal suspension in the working fluid.

### FIELD OF THE INVENTION

The present invention relates to a working fluid. More specifically the present invention relates to a working fluid for use in a heat transfer system, for example of the type used to transfer heat in a heat engine, heating or cooling systems, air conditioning systems or a closed circuit heat transfer system.

### BACKGROUND TO THE INVENTION

Working fluids may be gasses or liquids and are used to transport energy or to drive or actuate machinery. A working fluid is a liquid or gas that absorbs or transmits energy; working fluids may be used to transfer thermal energy from a first location to a second location, and/or may be used to actuate or drive a machine.

Energy is typically imparted to a working fluid by heating the working fluid (for example, by passing it through a heat exchanger or a solar thermal panel) or by compressing the working fluid.

Energy may be extracted from a working fluid in the form of heat (for example, by passing the working fluid through a heat exchanger) or by using the working fluid to produce mechanical work in an engine, for example, to drive a turbine or an expander.

Where working fluids receive heat from, or deliver heat to, other elements via heat exchangers, it is advantageous for the working fluid to have a high thermal conductivity so as to increase the rate of heat transfer (heat flux) between the working fluid and the other elements with which they are in thermal contact or connection. Therefore the higher the thermal conductivity the faster energy is transferred to and from the working fluid.

In addition to the thermal conductivity, there are a number of other properties of a heat transferring working fluid that need to be considered when designing a specific type of heat engine or heat transfer system. These include: the specific heat capacity of the working fluid, the viscosity of the working fluid and the density of the working fluid. It is desirable to be able to vary these variables.

They are also required in order to calculate the Reynolds number of a working fluid, within a specific flow regime and in different types of heat exchanger, in order to determine to what extent they affect the rate and nature of transfer of heat to or from the working fluid.

Some examples of heat transfer and heat storage mixtures are described in the following publications.

### PRIOR ART

European Patent Application EP 2 949 722 (Shenzhen Enesoon Science & Technology Co ltd) describes a nano molten salt heat transfer and heat storage medium and its method of preparation. The nano molten salt heat transfer and heat storage medium includes metal oxide nano-particles and/or non-metal oxide nano particles that are dispersed in molten salt to form the nano molten salt heat transfer and heat storage medium by composition. The heat transfer and heat storage medium has the good thermal stability and high thermal conductivity, which is ideally suited for industrial energy storage, thermal storage and transfer system of solar thermal power generation.

Chinese Patent Application CN107033852 (Beijing University of Technology) discloses a heat transfer medium and energy storage system. The heat transfer medium and energy storage system include a low-melting-point, binary nitric acid mixed molten salt nano-fluid.

The low-melting-point binary nitric acid mixed molten salt nano-fluid is made by compounding a low-cost low-melting-point mixed molten salt and nano particles. The low-cost low-melting-point mixed molten salt is mainly a mixture of potassium nitrate and calcium nitrate. Types of nano particles are one or two types of the following: SiO₂, Al₂O₃, TiO₂ and MgO nanoparticles. The low-melting-point binary nitric acid mixed molten salt nano-fluid has a melting temperature of 127.4° C., a decomposition temperature of 574.2° C., a specific heat capacity of about 1.73-1.91 J/(gK) and a heat conductivity coefficient of about 0.664 W/(mK).

US Patent Application US 2004/0206491 (Vanderbilt University and Tennessee Valley Authority) teaches a heat transfer composition and methods for using same for transferring heat. A heat transfer composition has soy-based oil, an additive comprising a nano-particle size diamond powder of a first mass, and a chemical agent of a second mass, wherein the ratio of the second mass to the first mass is greater than one.

US Patent Application US 2013/0119302 (Yen-Hao Huang et al) discloses an enhancing additive for increasing heat transfer efficiency. The additive consists of a nano-scale powder and a micro-scale powder that are added into a heat-transfer fluid circulating in a heat exchange system or in a coolant circulating in a cooling system. The additive enhances the heat conductivity of the heat-transfer fluid or the coolant while ensuring the heat exchange system and fluid passages are maintained clean, thereby enabling systems to operate with improved heat dissipation effect.

Chinese Patent Application CN105255452 (Kunming University of Science and Technology) teaches a nano cycle working medium used for a middle and low temperature organic Rankine cycle. Appropriate nanoparticles, base fluids and particle concentrations are employed for optimization to enhance heat transfer performance.

US Patent Application US 2014/0158931 (Commissariat A L'Energie Atomique et Aux Energies Alternatives) discloses a process for manufacturing nanoparticles that are self-dispersing in water. There is also disclosed a self-dispersing nanoparticle obtained by the process.

The process comprises: a) optionally, manufacture of an aqueous dispersion of nanoparticles chosen from the nanoparticles of: alumina (Al₂O₃), of zinc oxide (ZnO), of titanium oxide (TiO₂), of silica (SiO₂) and of beryllium oxide (BeO). These are added to an aqueous dispersion of nanoparticles chosen from nanoparticles of alumina (Al₂O₃), of zinc oxide (ZnO), of titanium oxide (TiO₂), of silica (Si₂) and of beryllium oxide (BeO), of a water-soluble polymer chosen from polyvinyl alcohols, polyethylene glycols, polyvinylpyrrolidones, polyoxazolines, starches, and mixtures of two or more thereof. Thermal quenching is then performed on the dispersion obtained.

US Patent Application US 2016/03764486 (King Fand University of Petroleum and Minerals) describes a nano-fluid comprising a base fluid and a solid nanocomposite particles, wherein the solid nanocomposite particle consists of a carbon nanotube and a metal oxide nanoparticle selected from the group consisting of: Fe₂O₃, Al₂O₃, and CuO. Metal oxide nanoparticles are affixed inside of, or to, the outer surface of the carbon nanotube and the solid nanocomposite particle is homogeneously dispersed in the base fluid.

International patent Application number WO 2017/109558 (Arcelormittal) teaches a method of heat transfer between a metallic or non-metallic item and a heat transfer fluid comprising a fluid medium and nanoparticles, wherein the thickness/lateral size ratio of such nanoparticles is below 0.00044 and wherein nanoparticles do not include carbon nanotubes.

An object of the present invention is to provide a working fluid with an improved thermal conductivity.

Another object of the present invention is to provide a method of increasing the thermal conductivity of a working fluid.

A further object of the present invention is to provide an improved working fluid with improved heat transfer capability.

A yet further object of the present invention is to provide a method of increasing the specific heat capacity of a working fluid. In this sense therefore the working fluid is able to produce a greater net output of work per cycle.

Another object is to provide a system for manufacturing the improved working fluid with improved heat transfer capability.

A yet further object of the present invention is to provide a method of increasing the specific heat capacity of a working fluid.

### STATEMENT OF THE INVENTION

According to a first aspect of the invention there is provided a working fluid comprising a plurality of nano-particles suspended in at least one hydro-fluoro-ether base fluid.

Suspending particles within a working fluid, which themselves have a higher thermal conductivity than the fluid, has been found to increase the thermal conductivity of a working fluid. Such a mixture is hereinafter referred to as a nano-fluid. Nano-fluids are fluids which include nano-particles, possibly in suspension within a liquid, in amounts and mixtures in order to vary one or more physical characteristic of the fluid.

Suspending nano-particles within a fluid has been found to increase the thermal conductivity of the fluid without significant clogging of conduits or causing other deleterious effects to machinery or equipment encountered in closed loop heat transfer systems, such as for example: expanders, throttles, mixers and one-way valves.

Nano-particles are typically particles with dimensions greater than 1 nm and typically less than around 100 nm; although in some embodiments particles with dimensions in the range 1 nm to 500 nm may be mixed with a fluid and are considered to fall within the class of nano-particles.

Typically a characteristic dimension of nano-particles may be length, width, height or diameter of a nano-particle.

Alternatively nano-particles may be spherical, tubular or fibrous with one or two characteristic dimensions of less than 100 nm.

It has been found that a suspension material may be used to assist or promote suspension nano-particles within the base fluid in order to increase the thermal conductivity of the fluid so as to increase the specific heat capacity of the fluid. An advantage of a suspension material is that it avoids or slows settling of the nano-particles.

Increasing the thermal conductivity of a working fluid tends to increase the rate at which heat is transferred to or from the working fluid, for example in use, in a heat exchanger or a solar thermal panel. Therefore working fluids comprising suspended nano-particles (so called nano-fluids) to transfer heat or drive a machine are more efficient than existing working fluids. Working fluids with higher specific heat capacities (due to the presence of the nano-particles) tend to undergo greater increases and rates of increase in temperature than other working fluids when the same amount of heat is transferred to the working fluid. These characteristics ensure that the nano-fluids comprising nano-particles allow the energy to be more rapidly transferred from the working fluid at a subsequent heat exchanger due to an increased temperature differential between the working fluid and the element to which heat is transferred from the fluid.

Use of certain types of nano-particle has been found to decrease the specific heat capacity of the fluid which may decrease the rate at which energy is transferred to the working fluid. As such the temperature differential between the working fluid and the source of energy decreases more rapidly as the working fluid is heated. However this effect may be compensated for by maintaining the temperature differential between the working fluid and the heat source, for example, by pumping the working fluid more rapidly through a heat exchanger.

The use of nano-particles (as opposed to millimetre or micrometre scale particles) to improve the thermal characteristics of the working fluid is considered to be advantageous as it reduces the risks of clogging of, or abrasion to the conduits through which the working fluid passes, flows or is pumped. Additionally, suspended nano-particles may be used to alter the viscosity of the working fluid.

A system for manufacturing a nano-fluid includes: a plurality of hoppers each containing at least one type of nano-particle; a reservoir containing a base fluid; control means associated with valves on the hoppers and a valve on the reservoir which valves are operable to dispense a user defined volume of working fluid and user defined amounts of nano-particles into a mixer tank; a mixer for mixing the nano-particles with the base fluid in the mixer tank to produce a nano-fluid; and a dispenser for dispensing the nano-fluid into storage containers.

Suspending particles within the working fluid has been found to increase the thermal heat transfer characteristics of the nano-fluid. Nano-fluids are fluids which include suspended nano-particles intended to vary one or more physical characteristic of the fluid. The nano-particles are ideally mixed so that they are suspended in the base fluid in a colloidal suspension.

In preferred embodiments, the materials from which the nano-particles are formed, ideally has a greater thermal conductivity than the base fluid.

The plurality of nano-particles may be—or may comprise—nano-particles of metal and/or metal oxide and/or metal nitride and/or metal silicide and/or metal carbide.

Ideally nano-particles include: boron carbine (B₄C), nano-particles of boron nitride (BN), nano-particles of beryllium oxide (BeO), nano-particles of magnesium oxide (MgO), nano-particles of graphite, nano-particles of silicon (Si), nano-particles of aluminium nitride (AlN), nano-particles of silicon carbide (SiC), nano-particles of aluminium oxide (Al₂O₃), nano-particles of titanium dioxide (TlO₂), nano-particles of silicon dioxide (SiO₂), nano-particles of copper (II) oxide (CuO), or any combination thereof.

Optionally the nano-particles include a graphene and/or reduced graphene mixture. In some embodiments a characteristic dimension (length or diameter) of the nano-particles is preferably smaller than 100 nm, preferably smaller than 75 nm, more preferably smaller than 50 nm, and most preferably smaller than 25 nm. Alternatively, or additionally, the nano-particles may have dimensions less than 90 nm, less than 70 nm, less than 45 nm, or less than 20 nm.

In some embodiments, the nano-particles may have dimensions greater than 5 nm, greater than 10 nm, or greater than 15 nm.

The base liquid comprises at least one hydro-fluoro-ether and may comprise at least 50% hydro-fluoro-ethers by volume. The base liquid may comprise at least one type of hydro-fluoro-ether, such as for example: HFE-7000 hydro-fluoro-ether or HFE-7100 hydro-fluoro-ether or a similar hydro-fluoro-ether. Ideally the liquid comprises at least 50% hydro-fluoro-ether by volume. It is therefore appreciated that different types of HFE fluid may be mixed in order to achieve desired properties of the working fluid.

Hydro-fluoro-ethers (HFEs) possess many benefits. Some of these are: it is a non-ozone-depleting chemical as it was originally developed as a replacement for CFCs and. It is odourless, non-flammable and exhibits low toxicity. It also has a low viscosity at room temperature and is similar in many respects to water at room temperature. Furthermore due to its high molecular weight, HFEs remains in the atmosphere for less than two weeks and tends to be absorbed into the ground rather than remaining dissolved in the atmosphere and exhibits negligible ozone depleting properties.

The volumetric concentration of nano-particles within the working fluid may be greater than 1%; it may be greater than 2%; it may be greater than 3%; it may be greater than 4%; it may be greater than 5%; it may be greater than 6%; it may be greater than 7%, or it may be less than 8%.

It is further appreciated that according to another aspect the invention also extends to a method of operating the aforementioned system for manufacturing a nano-fluid.

It is further understood that the invention extends to the use of a nano-fluid in a system and to use of such a system which employs the nano-fluid as hereindefined.

Preferred embodiments of the invention will now be described by way of examples only and with reference to the Figures, in which:

### BRIEF DESCRIPTION OF THE FIGURES

FIG. 1 is a table showing the increase in the heat transfer coefficient (W/(m²K) of a working fluid when different nano-particles are added at different volumetric concentrations;

FIG. 2 is Table 1 showing the power of a system performing an organic Rankine cycle when using different working fluids;

FIG. 3 is a diagram illustrating key steps in the production of a working fluid with different nano-particles; and

FIG. 4 is a basic functional diagram of a production plant for manufacturing working fluid with a range of different nano-particles.

### DETAILED DESCRIPTION OF THE FIGURES

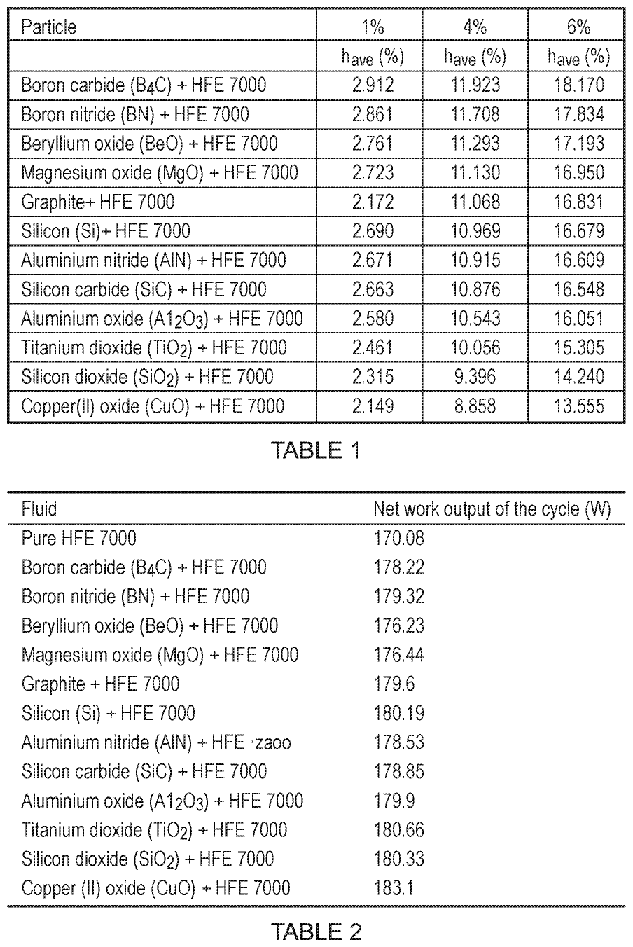

FIG. 1 is a table illustrating the percentage differences between the mean heat transfer coefficients of a HFE-7000 based working fluid and thirty-six different working nano-fluids, each of which comprises nano-particles of one of twelve different chemicals added to the HFE-7000 based working fluid at one of three different volumetric concentrations.

The thirty-six different basic working fluids, are described, these being separate example embodiments of the invention. A particularly preferred embodiment may be derived, for example by coating some of the nano-particles with graphene. A refinement of these additional variations may be obtained by coating nano-particles with a monolayer coating of graphene on nano-particles.

The twelve different chemicals from which the nano-particles comprised by the thirty-six working nano-fluids are formed are: boron carbine (B₄C), boron nitride (BN), beryllium oxide (BeO), magnesium oxide (MgO), graphite, graphene (reduced graphene), silicon (Si), aluminium nitride (AlN), silicon carbide (SiC), aluminium oxide (Al₂O₃), titanium dioxide (TlO₂), silicon dioxide (SiO₂), and copper (II) oxide (CuO).

The three different volumetric concentrations of the nano-particles within the working fluid being 1%, 4%, and 6% by volume.

The mean heat transfer coefficients of the HFE-7000 working fluid and the thirty-six working nano-fluids are measured when conducting heat in flows with Reynolds Number of around 1200.

The nano-particles of the thirty-six examples of working nano-fluids have dimensions of approximately 45 nm.

All thirty-six of the working nano-fluids have greater mean thermal conductivities than the HFE-7000 working fluid with no suspended nano-particles present.

FIG. 2 is a table illustrating the power output of as system performing an organic Rankine cycle between a solar thermal panel and an expander, when using thirteen different working fluids.

The thirteen working fluids are: pure HFE-7000, a nano-fluid comprising nano-particles of boron carbine (B₄C) suspended in HFE-7000, a nano-fluid comprising nano-particles of boron nitride (BN) suspended in HFE-7000, a nano-fluid comprising nano-particles of beryllium oxide (BeO) suspended in HFE-7000, a nano-fluid comprising nano-particles of magnesium oxide (MgO) suspended in HFE-7000, a nano-fluid comprising nano-particles of graphite suspended in HFE-7000, a nano-fluid comprising nano-particles of silicon (Si) suspended in HFE-7000, a nano-fluid comprising nano-particles of aluminium nitride (AlN) suspended in HFE-7000, a nano-fluid comprising nano-particles of silicon carbide (SiC) suspended in HFE-7000, a nano-fluid comprising nano-particles of aluminium oxide (Al₂O₃) suspended in HFE-7000, a nano-fluid comprising nano-particles of titanium dioxide (TlO₂) suspended in HFE-7000, a nano-fluid comprising nano-particles of silicon dioxide (SiO₂) suspended in HFE-7000, and a nano-fluid comprising nano-particles of copper (II) oxide (CuO) suspended in HFE-7000.

The nano-particles of the twelve working nano-fluids having dimensions of approximately 45 nm and volumetric concentrations within the working nano-fluids of 4%.

The system passes the working fluids through a solar thermal panel, upon which radiation of intensity 800 W/m² is incident. The working fluids are then passed through positive displacement expander where mechanical work is extracted from the working fluid. The working fluid then passes through a heat exchanger to a reservoir from which it is pumped back through the solar thermal panel. The pressure ratio of the system is 5:1.

In a preferred example embodiment of the invention the working fluid comprises 94% by volume HFE-7000, 6% by volume nano-particles of titanium dioxide (TiO₂) with dimensions greater than 40 nm and less than 50 nm.

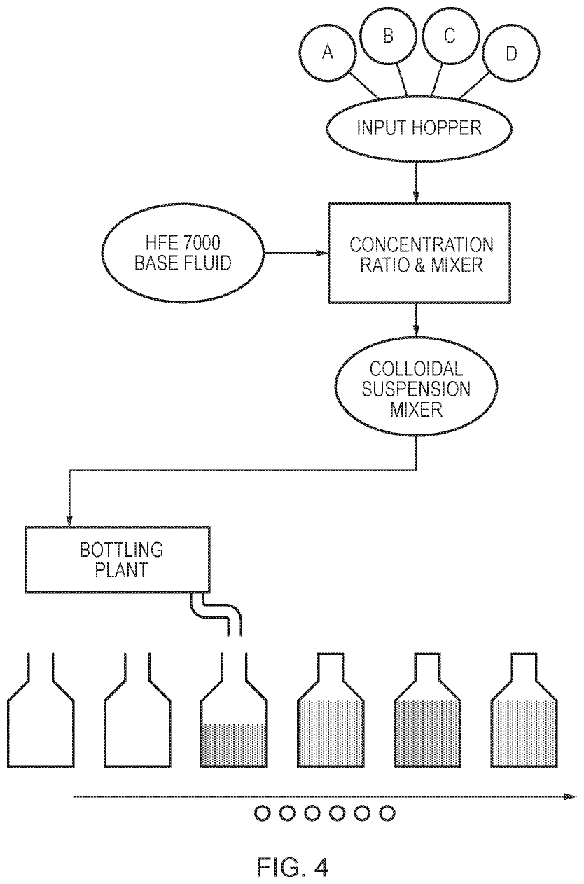

Referring to FIG. 4, tests were carried out in sealed glass containers, heated by part immersion in water. The water was initially checked to establish base visual and clarity. Water was heated to a maximum temperature of 90° C. and cooled using aluminium heat sinks (not shown). All temperatures were measured using thermo-couples with read-outs obtained automatically and displayed as outputs on a display (not shown). Initially all cooling was performed using a 1 mm thick aluminium heat sink (not shown). Subsequently cooling was carried out in free air, at ambient temperature without a heat sink.

The nano-particle mixture consisted of 6% (by volume) of copper oxide (CuO) nano particles in 94% (by volume) HFE-7000. The heating cycle, from room temperature to 90° C., was 20% faster than with water without the copper oxide nano particles. Identical cooling times showed the nano-particle mixture cooled 8.5% quicker than ?.

The nano-particle mixture consisting of 6% (by volume) of copper oxide (CuO) was then mixed with HFE 7100 which has a boiling point of 61° C. Similar maximum temperatures were attained in a shorter time.

Additionally, because of the molecular structure of HFE 7100 it also exhibited modest lubricant qualities and no corrosive activity was visible from any of the moving parts of pumps and expanders (not shown).

A further trial was performed used titanium oxide (TiO₂) at a concentration of 8% by volume. The mixture required little agitation to remain in suspension. When heated as a mixed, in the same volume of waters used for CuO, the titanium oxide (TiO₂) nano-fluid attained slighter higher temperature (boiled at 92° C.), and cooled over the same cooling period but at a slightly lower cooling rate. The titanium oxide mixture also remained in suspension for a longer time and needed less agitation than the nano-particle mixture consisting of 6% (by volume) of copper.

A further test was carried out using silicon oxide (SiO₂) nano-particles with identical ratio mix to the copper oxide nano-particle mixture. However, initial heat absorption was slower with the silicon oxide nano-particles. After around 4.5 minutes the temperature of the nano fluid with the silicon oxide nano-particles heated significantly faster than the CuO nano fluid. There was very little nano particle settlement throughout the heating and cooling cycle and almost no settling after several hours.

### CONCLUSIONS

All the samples used displayed improved heat transfer properties, thus efficiency; used within systems employing fluid as the heat transfer medium, is enhanced proportionally.

From the above titanium oxide and silicon dioxide appear to offer good heat transfer properties and showed good heat retention and heat release properties. They also tended to remain in suspension and showed little signs of settlement. This is considered to offer a benefit during maintenance.

Silicon dioxide shows the best overall potential for a wide range of applications, of the nano-particles tested.

### Results

Quoted figures are degrees Celsius and are achieved using free air cooling over the same time interval. Table 2 shows results of preliminary trials using mixtures of HFE with copper oxide and silicon dioxide.

TABLE 2

| Nano particle | Fluid | Max temp | Cooled temp |
|---|---|---|---|
| CuO | water | 91 | 40 |
| CuO | HFE | 90 | 40 |
| | 7100 | | |
| TiO₂ | HFE | 92 | 44 |
| SiO₂ | HFE | 87 | 45 |

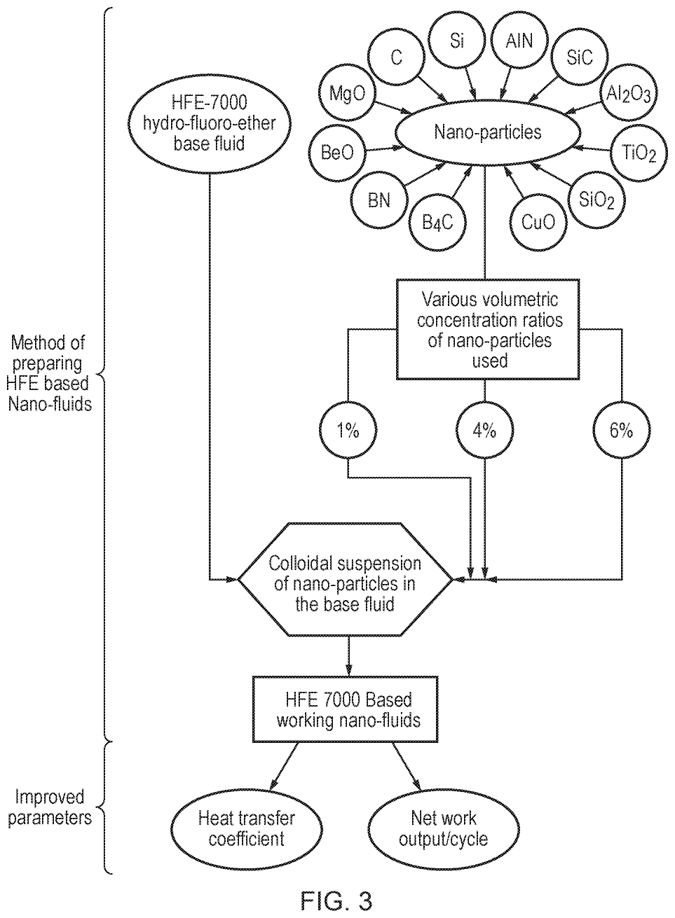

Referring briefly to FIG. 3 which illustrates key steps in the manufacture of a working fluid with different nano-particles. FIG. 4 is a basic functional diagram of a production plant for manufacturing working fluid with different types of nano-particles that can be added and mixed in different ratios to the HFE liquid and shows in diagrammatical form key stages in production. Input hoppers A, B, C and D have different nano-particles and valves (not shown) deliver predefined volumes of each nano-particle into a main hopper for mixing with a base fluid into a colloidal suspension.

It is apparent that the invention may be included in heat transfer systems for use for example in buildings and/or vehicles in which heat needs to be transferred to cooler zones or from hotter zones. Examples of systems include: air-condoning units, combined heat and power units and blowers, for example for warming cabs in vehicles or rooms. The improved heat transfer efficiency of the working fluid enables heat energy to be transferred more efficiently (quicker and with less pumping power) than was previously the case and so provides for lighter and more compact heat transfer systems.

The invention has been described by way of example only and it will be appreciated that variation may be made to the embodiments described above without departing from the scope of the claims.

1. A working fluid comprising a plurality of nano-particles suspended in at least one hydro-fluoro-ether base fluid.

2. A working fluid according to claim 1 wherein the nano-particles are suspended in the base fluid in a colloidal suspension.

3. A working fluid according to claim 1 or claim 2 wherein the plurality of nano-particles comprise nano-particles of boron carbine (B₄C), nano-particles of boron nitride (BN), nano-particles of beryllium oxide (BeO), nano-particles of magnesium oxide (MgO), nano-particles of graphite, nano-particles of silicon (Si), nano-particles of aluminium nitride (AlN), nano-particles of silicon carbide (SiC), nano-particles of aluminium oxide (Al₂O₃), nano-particles of titanium dioxide (TiO₂), nano-particles of silicon dioxide (SiO₂), nano-particles of copper (II) oxide (CuO), or any combination thereof.

4. A working fluid according to any preceding claim wherein the plurality of nano-particles comprises nano-particles of boron carbide (B₄C).

5. A working fluid according to any preceding claim wherein the plurality of nano-particles comprises nano-particles of boron nitride (BN).

6. A working fluid according to any preceding claim wherein the plurality of nano-particles comprises nano-particles of beryllium oxide (BeO).

7. A working fluid according to any preceding claim wherein the plurality of nano-particles comprises nano-particles of magnesium oxide (MgO).

8. A working fluid according to any preceding claim wherein the plurality of nano-particles comprises nano-particles of graphite or graphene.

9. A working fluid according to any preceding claim wherein the plurality of nano-particles comprises nano-particles of silicon (Si).

10. A working fluid according to any preceding claim wherein the plurality of nano-particles comprises nano-particles of aluminium nitride (AlN).

11. A working fluid according to any preceding claim wherein the plurality of nano-particles comprises nano-particles of silicon carbide (SiC).

12. A working fluid according to any preceding claim wherein the plurality of nano-particles comprises nano-particles of aluminium oxide (Al₂O₃).

13. A working fluid according to any preceding claim wherein the plurality of nano-particles comprises nano-particles of titanium dioxide (TiO₂).

14. A working fluid according to any preceding claim wherein the plurality of nano-particles comprises nano-particles of silicon dioxide (SiO₂).

15. A working fluid according to any preceding claim wherein the plurality of nano-particles comprises nano-particles of copper (II) oxide (CuO).

16. A working fluid according to any preceding claim wherein nano-particles have at least two characteristic dimensions less than 100 nm.

17. A working fluid according to any preceding claim wherein nano-particles have dimensions less than 100 nm.

18. A working fluid according to any preceding claim wherein nano-particles have at least two dimensions less than 75 nm.

19. A working fluid according to any preceding claim wherein nano-particles have dimensions less than 75 nm.

20. A working fluid according to any preceding claim wherein nano-particles have at least two dimensions less than 50 nm.

21. A working fluid according to any preceding claim wherein nano-particles have dimensions less than 50 nm.

22. A working fluid according to any preceding claim wherein nano-particles have at least two dimensions less than 25 nm.

23. A working fluid according to any preceding claim wherein nano-particles have dimensions less than 25 nm.

24. A working fluid according to any preceding claim wherein the nano-particles have dimensions greater than nm.

25. A working fluid according to any preceding claim wherein the nano-particles have dimensions greater than 10 nm.

26. A working fluid according to any preceding claim wherein the nano-particles have dimensions greater than 15 nm.

27. A working fluid according to any preceding claim wherein the base fluid is at least 50% hydro-fluoro-ethers by volume.

28. A working fluid according to any preceding claim wherein the base fluid comprises HFE-7000 hydro-fluoro-ether.

29. A working fluid according to any preceding claim wherein the base fluid is at least 50% HFE-7000 hydro-fluoro-ether by volume.

30. A working fluid according to any preceding claim wherein the volumetric concentration of the nano-particles within working fluid is greater than 1%.

31. A working fluid according to any preceding claim wherein the volumetric concentration of the nano-particles within working fluid is greater than 2%.

32. A working fluid according to any preceding claim wherein the volumetric concentration of the nano-particles within working fluid is greater than 3%.

33. A working fluid according to any preceding claim wherein the volumetric concentration of the nano-particles within working fluid is greater than 4%.

34. A working fluid according to any preceding claim wherein the volumetric concentration of the nano-particles within working fluid is greater than 5%.

35. A working fluid according to any preceding claim wherein the volumetric concentration of the nano-particles within working fluid is greater than 6%.

36. A working fluid according to any preceding claim wherein the volumetric concentration of the nano-particles within working fluid is greater than 7%.

37. A working fluid according to any preceding claim wherein the volumetric concentration of the nano-particles within the working fluid is less than 8%.

38. A working fluid according to any of claims 1 to 35 wherein the volumetric concentration of the nano-particles within the working fluid is less than 7%.

39. A working fluid according to any of claims 1 to 34 wherein the volumetric concentration of the nano-particles within the working fluid is less than 6%.

40. A working fluid according to any of claims 1 to 33 wherein the volumetric concentration of the nano-particles within the working fluid is less than 5%.

41. A working fluid according to any of claims 1 to 32 wherein the volumetric concentration of the nano-particles within the working fluid is less than 4%.

42. A working fluid according to any of claims 1 to 31 wherein the volumetric concentration of the nano-particles within the working fluid is less than 3%.

43. A working fluid according to any of claims 1 to 30 wherein the volumetric concentration of the nano-particles within the working fluid is less than 2%.

44. A working fluid according to any of claims 1 to 29 wherein the volumetric concentration of the nano-particles within the working fluid is less than 1%.

45. A working fluid according to any preceding claim wherein the heat transfer property of the base fluid which is improved is the heat transfer coefficient (h).

46. A system for manufacturing a working fluid according to any of claims 1 to 45 including a plurality of hoppers each containing at least one type of nano-particle; a reservoir containing the at least one base fluid; control means associated with valves on the hoppers and a valve on the reservoir, the valves are operable to dispense a user defined volume of base fluid and user defined amounts of nano-particles into a mixer tank; a mixer for mixing the nano-particles with the base fluid in the mixer tank to produce a nano-fluid; and a dispenser for dispensing the working fluid into storage containers.

47. A system according to claim 46 wherein the mixer is operative to mix the nano-particles and the at least one base fluid until the nano-particles are suspended in the base fluid in a colloidal suspension.

48. A method of operating the system for manufacturing a working fluid according to either claim 46 or 47.
